(19) United States
(12) Patent Application Publication
(10) Pub. No.: US 2025/0156138 A1
(43) Pub. Date: May 15, 2025

(54) DISPLAY SYSTEM

(71) Applicant: LG ELECTRONICS INC., Seoul (KR)

(72) Inventors: Jin Yung PARK, Seoul (KR); Jung Bin LEE, Seoul (KR); Min Young JO, Seoul (KR); Seung Il LEE, Seoul (KR); Jin Wan BAE, Seoul (KR); Ji Youn CHA, Seoul (KR); Youn Kyung LEE, Seoul (KR)

(73) Assignee: LG ELECTRONICS INC., Seoul (KR)

(21) Appl. No.: 18/837,675

(22) PCT Filed: Dec. 30, 2022
(86) PCT No.: PCT/KR2022/021739

§ 371 Date: Aug. 12, 2024

(30) Foreign Application Priority Data
Feb. 10, 2022 (KR) 10-2022-0017458

(51) Int. Cl. G06F 3/147; G06F 3/0482

(52) U.S. Cl. CPC G06F 3/147; G06F 3/0482; G06F 2203/04806

(57) ABSTRACT

In a display system comprising a first display device and a second display device according to an embodiment of the present invention, the first display device determines whether the second display device is attached, and when it is determined that the second display device is attached, the second display device can display, on the basis of a first content image being displayed, a second content image related to the first content image.

### TECHNICAL FIELD

The present disclosure relates to a display system that is attachable and detachable between two display devices.

### BACKGROUND ART

Digital TV services using wired or wireless communication networks are becoming popular. Digital TV services may provide a variety of services that may not be provided by existing analog broadcasting services.

For example, IPTV (Internet Protocol Television) and smart TV services, which are types of digital TV services, provide interactivity that allows users to actively select the type of program to watch and the viewing time. IPTV and smart TV services may provide various additional services, such as Internet search, home shopping, and online games, based on this interactivity.

The TV provides a mirroring function in conjunction with smartphones and smart pads. However, the two devices are typically physically separated, limiting the user experience they can provide.

### DISCLOSURE

### Technical Problem

An object of the present disclosure is to provide a variety of user experiences through two attachable and detachable display devices.

An object of the present disclosure is to enable users to quickly obtain desired information while watching content through interworking between two display devices.

### Technical Solution

A display system including a first display device and a second display device according to an embodiment of the present disclosure, in which the first display device may determine whether the second display device is attached, and based on a determination that the second display device is attached, the second display device may display a second content image related to the first content image based on the first content image being displayed by the second display device.

### Advantageous Effect

According to an embodiment of the present disclosure, an improved user experience may be provided through attachment and detachment between two display devices.

According to an embodiment of the present disclosure, while watching a content image through the main screen, a user may conveniently check information on an object identified from the content image through a sub-screen attached to the main screen.

Additionally, users may easily control the dual screen with simple gestures.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device according to an embodiment of the present disclosure.

FIG. 4 is a view illustrating an example of utilizing a remote control device according to an embodiment of the present disclosure.

FIG. 5a is a view describing a process of detaching a display system according to an embodiment of the present disclosure, and FIG. 5b is a view describing a process of attaching a display system according to an embodiment of the present disclosure.

FIG. 6 is a ladder diagram for describing a method of operating a display system according to an embodiment of the present disclosure.

FIG. 7 is a view illustrating an actual use scenario of FIG. 6.

FIG. 8 is a ladder diagram for describing a method of operating a display system according to an embodiment of the present disclosure.

FIGS. 9a to 9c is a view illustrating a process in which an application to be executed on the first display device is determined according to an app running on the second display device when the second display device is attached to the first display device according to an embodiment of the present disclosure.

FIG. 10 is a ladder diagram for describing a method of operating a display system according to another embodiment of the present disclosure.

FIG. 11 is a view illustrating a usage scenario of the embodiment of FIG. 10.

FIGS. 12a to 13 are views illustrating a process of switching the screen according to a gesture in a state where the first display device and the second display device are separated.

### BEST MODE

Hereinafter, embodiments relating to the present disclosure will be described in detail with reference to the accompanying drawings. The suffixes “module” and “unit” for components used in the description below are assigned or mixed in consideration of easiness in writing the specification and do not have distinctive meanings or roles by themselves.

The display device according to an embodiment of the present disclosure is, for example, an intelligent display device that adds a computer support function to the broadcast reception function, and is faithful to the broadcast reception function while adding an Internet function or the like, and thus it can be equipped with a more convenient interface such as a handwriting input device, a touch screen, and a spatial remote control. In addition, by supporting wired or wireless Internet functions, it is possible to connect to the Internet and a computer and perform functions such as email, web browsing, banking, or gaming. A standardized general-purpose OS may be used for these various functions.

Accordingly, in the display device described in the present disclosure, for example, various applications may be freely added or deleted on a general-purpose OS kernel, so various user-friendly functions may be performed. More specifically, the display device may be, for example, a network TV, HBBTV, smart TV, LED TV, OLED TV, or the like, and in some cases, may also be applied to a smartphone.

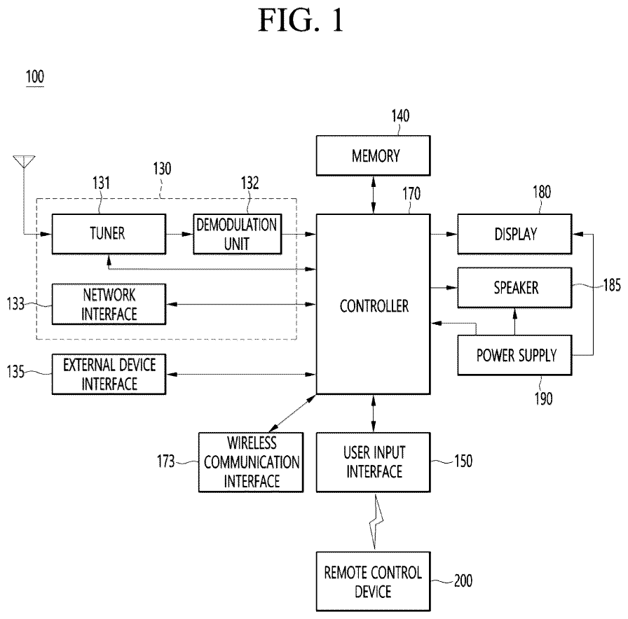

FIG. 1 is a block diagram illustrating a configuration of a display device according to an embodiment of the present disclosure.

Referring to FIG. 1, a display device 100 may include a broadcast reception module 130, an external device interface 135, a memory 140, a user input interface 150, a controller 170, a wireless communication interface 173, a display 180, an speaker 185, and a power supply 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program-related data signals, and may restore the divided video signals, audio signals, and data signals into an output available form.

The external device interface 135 may receive an application or an application list in an adjacent external device and deliver the application or the application list to the controller 170 or the memory 140.

The external device interface 135 may provide a connection path between the display device 100 and an external device. The external device interface 135 may receive at least one of an image or audio outputted from an external device that is wirelessly or wiredly connected to the display device 100 and deliver the received image or the audio to the controller. The external device interface 135 may include a plurality of external input terminals. The plurality of external input terminals may include an RGB terminal, at least one High Definition Multimedia Interface (HDMI) terminal, and a component terminal.

An image signal of an external device inputted through the external device interface 135 may be outputted through the display 180. A sound signal of an external device inputted through the external device interface 135 may be outputted through the speaker 185.

An external device connectable to the external device interface 135 may be one of a set-top box, a Blu-ray player, a DVD player, a game console, a sound bar, a smartphone, a PC, a USB

Memory, and a home theater system but this is just exemplary.

The network interface 133 may provide an interface for connecting the display device 100 to a wired/wireless network comprising internet network. The network interface 133 may transmit or receive data to or from another user or another electronic device through an accessed network or another network linked to the accessed network.

Additionally, some content data stored in the display device 100 may be transmitted to a user or an electronic device, which is selected from other users or other electronic devices pre-registered in the display device 100.

The network interface 133 may access a predetermined webpage through an accessed network or another network linked to the accessed network. In other words, the network interface 133 may transmit or receive data to or from a corresponding server by accessing a predetermined webpage through the network.

The network interface 133 may receive content or data provided from a content provider or a network operator. In other words, the network interface 133 may receive content, such as movies, advertisements, games, VODs, and broadcast signals, which are provided from the content provider or the network operator, and information relating thereto through the network.

In addition, the network interface 133 may receive firmware update information and update files provided from the network operator, and may transmit data to the Internet or content provider or the network operator.

The network interface 133 may select and receive a desired application among applications open to the air, through network.

The memory 140 may store signal-processed image, voice, or data signals stored by a program in order for each signal processing and control in the controller 170.

In addition, the memory 140 may perform a function for temporarily storing image, voice, or data signals output from the external device interface 135 or the network interface 133, and may store information on a predetermined image through a channel memory function.

The memory 140 may store an application or an application list input from the external device interface 135 or the network interface 133.

The display device 100 may play content files (e.g., video files, still image files, music files, document files, application files, etc.) stored in the memory 140, and may provide the content files to a user.

The user input interface 150 may transmit signals input by a user to the controller 170, or may transmit signals from the controller 170 to a user. For example, the user input interface 150 may receive or process control signals such as power on/off, channel selection, and screen setting from the remote control device 200 or transmit control signals from the controller 170 to the remote control device 200 according to various communication methods such as Bluetooth, Ultra Wideband (WB), ZigBee, Radio Frequency (RF), and IR communication methods.

In addition, the user input interface 150 may transmit, to the controller 170, control signals input from local keys (not shown) such as a power key, a channel key, a volume key, and a setting key.

Image signals that are image-processed by the controller 170 may be input to the display 180 and displayed as images corresponding to the image signals. In addition, image signals that are image-processed by the controller 170 may be input to an external output device through the external device interface 135.

Voice signals processed by the controller 170 may be output to the speaker 185. In addition, voice signals processed by the controller 170 may be input to the external output device through the external device interface 135.

Additionally, the controller 170 may control overall operations of the display device 100.

In addition, the controller 170 may control the display device 100 by a user command or an internal program input through the user input interface 150, and may access the network to download a desired application or application list into the display device 100.

The controller 170 may output channel information selected by a user together with the processed image or voice signals through the display 180 or the speaker 185.

In addition, the controller 170 may output image signals or voice signals of an external device such as a camera or a camcorder, which are input through the external device interface 135, through the display 180 or the speaker 185, according to an external device image playback command received through the user input interface 150.

Moreover, the controller 170 may control the display 180 to display images, and may control the display 180 to display broadcast images input through the tuner 131, external input images input through the external device interface 135, images input through the network interface, or images stored in the memory 140. In this case, an image displayed on the display 180 may be a still image or video and also may be a 2D image or a 3D image.

Additionally, the controller 170 may play content stored in the display device 100, received broadcast content, and external input content input from the outside, and the content may be in various formats such as broadcast images, external input images, audio files, still images, accessed web screens, and document files.

The wireless communication interface 173 may perform wired or wireless communication with an external device. The wireless communication interface 173 may perform short-range communication with an external device. For this, the wireless communication interface 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, or Wireless Universal Serial Bus (USB) technologies. The wireless communication interface 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication interface 173 may detect (or recognize) a wearable device capable of communication around the display device 100.

Furthermore, if the detected wearable device is a device authenticated to communicate with the display device 100, the controller 170 may transmit at least a part of data processed in the display device 100 to the wearable device through the wireless communication interface 173. Therefore, a user of the wearable device may use the data processed by the display device 100 through the wearable device.

The display 180 may convert image signals, data signals, or on-screen display (OSD) signals, which are processed in the controller 170, or images signals or data signals, which are received in the external device interface 135, into R, G, and B signals to generate driving signals. Furthermore, the display device 100 shown in FIG. 1 is just one embodiment of the present disclosure and thus, some of the components shown may be integrated, added, or omitted according to the specification of the actually implemented display device 100.

In other words, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface 133 or the external device interface 135 and play them without including the tuner 131 and the demodulation unit 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display 180 and the speaker 185.

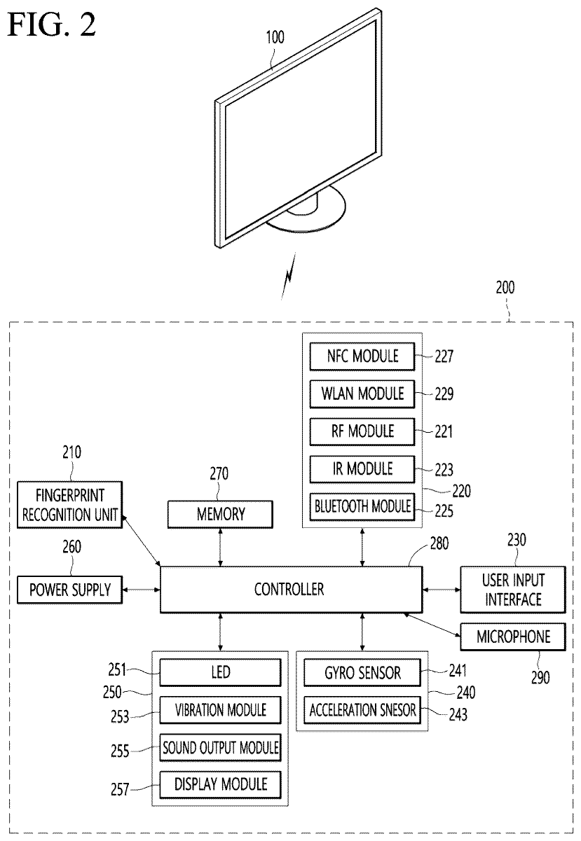

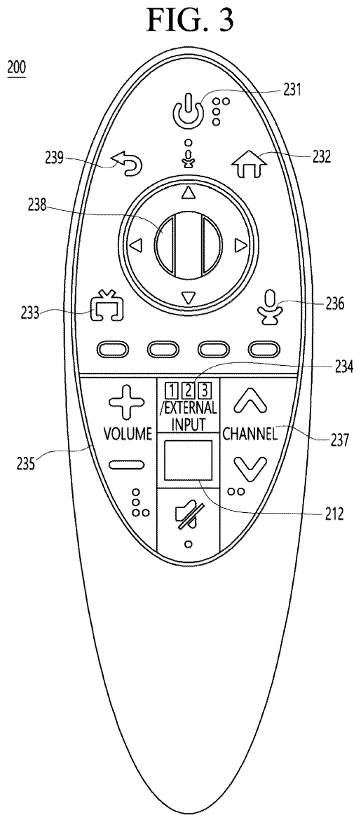

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition unit 210, a wireless communication interface 220, a user input interface 230, a sensor unit 240, an output unit 250, a power supply 260, a memory 270, a controller 280, and a microphone 290.

Referring to FIG. 2, the wireless communication interface 220 transmits/receives signals to/from an arbitrary any one of display devices according to the above-mentioned embodiments of the present disclosure.

The remote control device 200 may include a radio frequency (RF) module 221 capable of transmitting or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication interface 220.

Moreover, the remote control device 200 may receive signals transmitted from the display device 100 through the RF module 221 and if necessary, may transmit a command for power on/off, channel change, and volume change to the display device 100 through the IR module 223.

The user input interface 230 may be configured with a keypad, a button, a touch pad, or a touch screen. A user may operate the user input interface 230 to input a command relating to the display device 100 to the remote control device 200. If the user input interface 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation.

The power button 231 may be a button for turning on/off the power of the display device 100.

The home button 232 may be a button for moving to the home screen of the display device 100.

The live button 233 may be a button for displaying live broadcast programs.

The external input button 234 may be a button for receiving an external input connected to the display device 100.

The volume control button 235 may be a button for controlling a volume output from the display device 100.

The voice recognition button 236 may be a button for receiving user's voice and recognizing the received voice.

The channel change button 237 may be a button for receiving broadcast signals of a specific broadcast channel.

The OK button 238 may be a button for selecting a specific function, and the back button 239 may be a button for returning to a previous screen.

FIG. 2 is described again.

If the user input interface 230 includes a touch screen, a user may touch a soft key of the touch screen to input a command relating to the display device 100 to the remote control device 200. In addition, the user input interface 230 may include various kinds of input interfaces operable by a user, for example, a scroll key and a jog key, and this embodiment does not limit the scope of the present disclosure.

The sensor unit 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display 180 of the display device 100.

The output unit 250 may output image or voice signals in response to the operation of the user input interface 230, or may output image or voice signals corresponding to signals transmitted from the display device 100.

A user may recognize whether the user input interface 230 is operated or the display device 100 is controlled through the output unit 250.

For example, the output unit 250 may include an LED module 251 for flashing, a vibration module 253 for generating vibration, a sound output module 255 for outputting sound, or a display module 257 for outputting an image, if the user input interface 230 is manipulated or signals are transmitted/received to/from the display device 100 through the wireless communication interface 220.

Additionally, the power supply 260 supplies power to the remote control device 200 and if the remote control device 200 does not move for a predetermined time, stops the power supply, so that power waste may be reduced.

The power supply 260 may resume the supply of power if a predetermined key provided at the remote control device 200 is operated.

The memory 270 may store various kinds of programs and application data required to control or operate the remote control device 200.

If the remote control device 200 transmits/receives signals wirelessly through the display device 100 and the RF module 221, the remote control device 200 and the display device 100 transmits/receives signals through a predetermined frequency band.

The controller 280 of the remote control device 200 may store, in the memory 270, information on a frequency band for transmitting/receiving signals to/from the display device 100 paired with the remote control device 200 and refer to it.

The controller 280 controls general matters relating to the control of the remote control device 200. The controller 280 may transmit a signal corresponding to a predetermined key operation of the user input interface 230 or a signal corresponding to the movement of the remote control device 200 sensed by the sensor unit 240 to the display device 100 through the wireless communication interface 220.

In addition, the microphone 290 of the remote control device 200 may acquire voice.

The microphone 290 may be provided in plural.

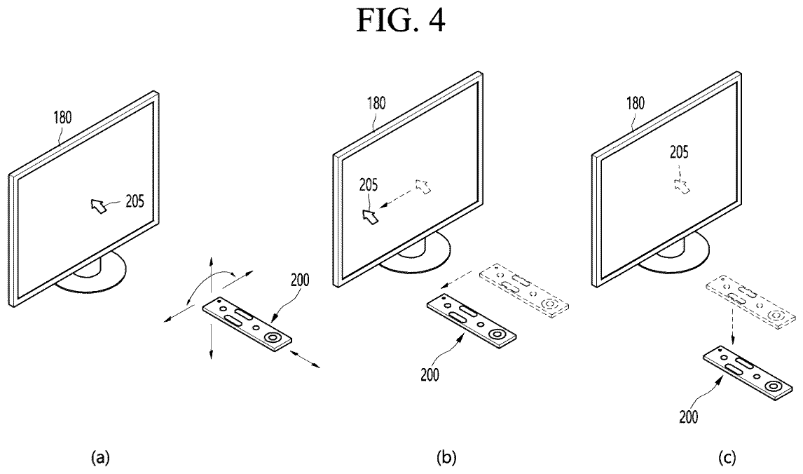

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display 180.

A user may move or rotate the remote control device 200 vertically or horizontally. The pointer 205 displayed on the display 180 of the display device 100 corresponds to a movement of the remote control device 200. Since the corresponding pointer 205 is moved and displayed according to a movement on a 3D space as show in the drawing, the remote control device 200 may be referred to as a spatial remote control device.

FIG. 4(b) illustrates that if a user moves the remote control device 200, the pointer 205 displayed on the display 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display 180. Thus, a selected region in the display 180 corresponding to the pointer 205 may be zoomed in and displayed in an enlarged size.

On the other hand, if a user moves the remote control device 200 close to the display 180, a selection area in the display 180 corresponding to the pointer 205 may be zoomed out and displayed in a reduced size.

On the other hand, if the remote control device 200 is moved away from the display 180, a selection area may be zoomed out and if the remote control device 200 is moved closer to the display 180, a selection area may be zoomed in.

Additionally, if a specific button in the remote control device 200 is pressed, recognition of a vertical or horizontal movement may be excluded. In other words, if the remote control device 200 is moved away from or closer to the display 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display 180 and also may be displayed in correspondence to a plurality of points such as a line and a surface.

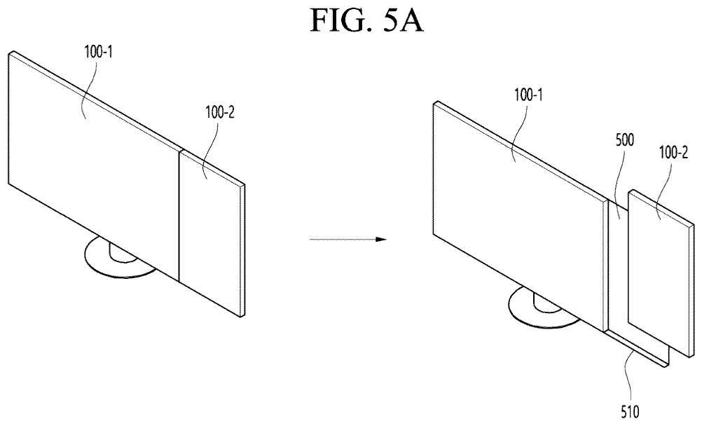

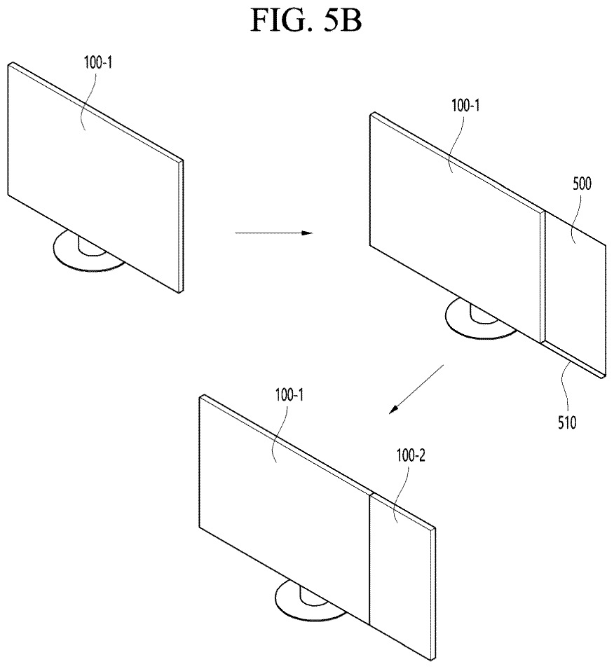

FIG. 5a is a view describing a process of detaching a display system according to an embodiment of the present disclosure, and FIG. 5b is a view describing a process of attaching a display system according to an embodiment of the present disclosure.

The display system may include a first display device 100-1 and a second display device 100-2.

Each of the first display device 100-1 and the second display device 100-2 may include all of the components of the display device 100 described in FIG. 1.

The screen size of the first display device 100-1 may be larger than that of the second display device 100-2.

The screen of the first display device 100-1 may be referred to as a main screen, and the screen of the second display device 100-2 may be referred to as a sub-screen.

The first display device 100-1 and the second display device 100-2 may be connected to each other through a wireless communication standard. For this purpose, the wireless communication interface 173 of FIG. 1 may be used.

Referring to FIG. 5a, one side surrounding the first display device 100-1 and one side surrounding the second display device 100-2 are attached. Magnets may be attached to each of one side of the first display device 100-1 and one side of the second display device 100-2.

In other words, each of the first display device 100-1 and the second display device 100-2 may be attached and detached from each other through magnets.

A mounting support 500 on which the second display device 100-2 may be mounted may be provided at the rear surface of the first display device 100-1.

The user may attach or detach the second display device 100-2 from the first display device 100-1 through the mounting support 500.

A sliding part 510 may be provided at the lower end of the mounting support 500. The sliding part 510 may slide the first display device 100-1 or the second display device 100-2 in the horizontal direction.

Referring to FIG. 5b, when the first display device 100-1 slides in the left direction, a portion of the mounting support 500 may be exposed.

A user may mount the second display device 100-2 on a portion of the exposed mounting support 500. Accordingly, the first display device 100 and the second display device 100-2 may be attached to each other.

Meanwhile, the mounting support 500 may be provided with a wireless charging circuit for wireless charging. When the first display device 100-1 or the second display device 100-2 is equipped with a wireless power reception circuit, the wireless charging function may be performed simply by placing the first display device 100-1 or the second display device 100-2 on the mounting support 500.

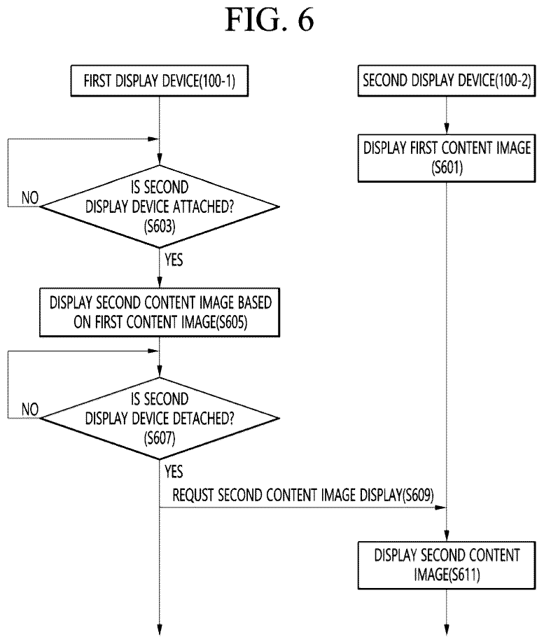

FIG. 6 is a ladder diagram for describing a method of operating a display system according to an embodiment of the present disclosure.

Hereinafter, the components of each of the first and second display devices 100-1 and 100-2 are assumed to include the components shown in FIG. 1. For convenience, the components of the first display device 100-1 are expressed in a format such as (xxx-1), and the components of the second display device 100-2 are expressed in a format such as (xxx-2). For example, the controller of the first display device 100-1 is indicated as 170-1, and the controller of the second display device 100-2 is indicated as 170-2.

Referring to FIG. 6, while the second display device 100-2 is displaying the first content image on the display 180-2 (S601), the controller 170-1 of the first display device 100-1 determines whether the second display device 100-2 is attached (S603).

When the controller 170-1 of the first display device 100-1 detects magnetic force between a magnet attached to one surface of the controller 170-1 and a magnet attached to one surface of the second display device 100-2, it may be determined that the second display device 100-2 is attached.

When the second display device 100-2 is placed on the mounting support 500 and magnetic force is detected, the controller 170-1 of the first display device 100-1 may determine that the second display device 100-2 is attached.

In one embodiment, when the second display device 100-2 is attached to the first display device 100-1, a wireless connection to each other may be automatically established. The communication standard used for wireless connection may be either Bluetooth or Wi-Fi, but this is only an example. In this case, attachment to each other may be a trigger for a wireless connection.

In another embodiment, the first display device 100-1 and the second display device 100-2 may be attached to each other while connected to a network.

When the second display device 100-2 is attached, the controller 170-1 of the first display device 100-1 displays a second content image based on the first content image on the display 180-1 (S605).

In one embodiment, the second content image may be an image related to the first content image. Specifically, the second content image may be a partial image of the first content image.

For example, if the first content image includes the other party's image and a chat window, the second content image may only show the camera image.

In other words, the controller 170-1 of the first display device 100-1 may extract the other person's image from the first content image and display the extracted other person's image on the display 180-1. Accordingly, users can easily chat while watching the other person's image on a large screen.

In another embodiment, the screen of the first display device 100-1 may be larger than the screen of the second display device 100-2. The second content image may be an enlarged image of the first content image.

Afterwards, the controller 170-1 of the first display device 100-1 determines whether the second display device 100-2 has been detached (S607).

When the controller 170-1 of the first display device 100-1 does not detect magnetic force between the magnet attached to one surface of the controller 170-1 and the magnet attached to one surface of the second display device 100-2, it may be determined that the second display device 100-2 is detached.

When the second display device 100-2 is spaced apart from the mounting support 500 and magnetic force is not detected, the controller 170-1 of the first display device 100-1 may determine that second display device 100-2 is detached.

When the second display device 100-2 is detached, the controller 170-1 of the first display device 100-1 transmits a second content image display request to the second display device 100-2 through the wireless communication interface 173-1 (S609).

The controller 170-2 of the second display device 100-2 displays the second content image on the display 180-2 in response to the second content image display request (S611).

While watching the second content image through the first display device 100-1, the user may remove the second display device 100-2 and move the second display device 100-2 to another location to continuously enjoy the second content image.

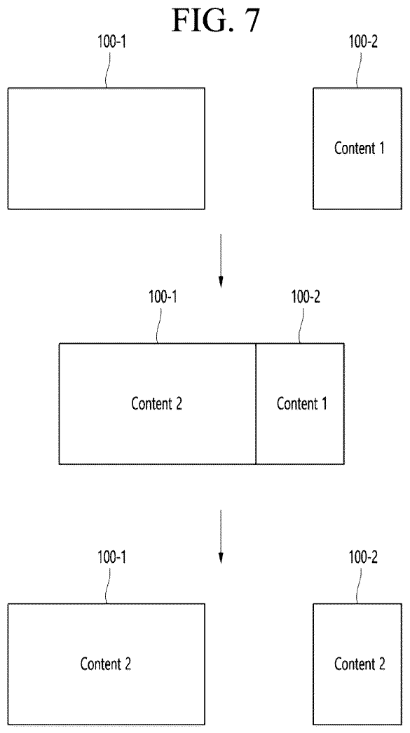

FIG. 7 is a view illustrating an actual use scenario of FIG. 6.

Referring to FIG. 7, the first display device 100-1 and the second display device 100-2 are in a state of being detached from each other.

The first display device 100-1 may display a standby screen operating in a low power mode or may be in an off state. The second display device 100-2 displays the first content image (content 1).

When the first display device 100-1 detects that the second display device 100-2 is attached, it may display the second content image (content 2) based on the first content image (content 1).

The second content image (content 2) may be an enlarged image of a portion of the first content image (content 1).

While watching the enlarged first content image (content 1) through the first display device 100-1, the user may attach and detach the second display device 100-2 for movement. In this case, the second display device 100-2 may display the second content image 100-2.

In other words, as the second display device 100-2 is separated from the first display device 100-1, the first content image (content 1) may be converted to the second content image (content 2).

Even while moving, the user may maintain watching the second content image (content 2) through the second display device 100-2.

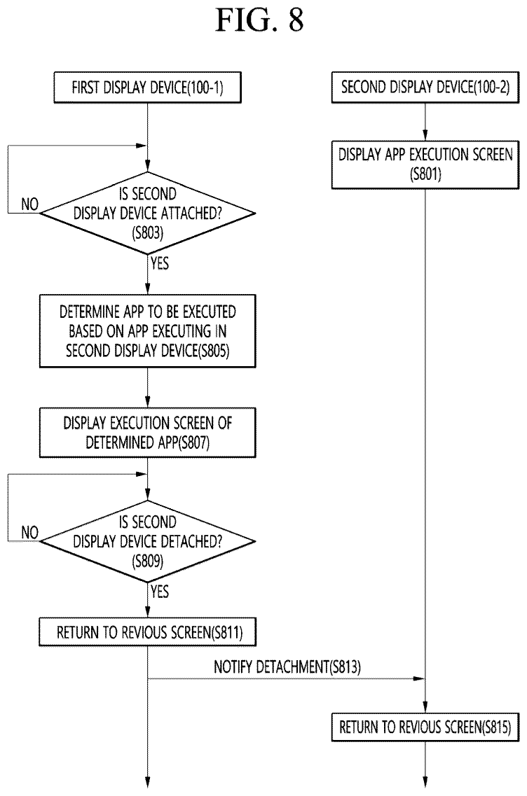

FIG. 8 is a ladder diagram for describing a method of operating a display system according to an embodiment of the present disclosure.

Hereinafter, app may be an abbreviation for application.

The controller 170-2 of the second display device 100-2 displays an app execution screen on the display 180-2 (S801).

The controller 170-2 of the second display device 100-2 may display an app execution screen according to an execution of the first application.

At this time, the first display device 100-1 may be in a screen-off state or an Always On Display (AOD) state. The AOD state may be a state where the display is turned on by driving only minimal power.

While the second display device 100-2 is displaying the app execution screen on the display 180-2 (S801), the controller 170-1 of the first display device 100-1 determines whether the second display device 100-2 is attached (S803).

When the second display device 100-2 is attached, the controller 170-1 of the first display device 100-1 determines the app executed by the controller based on the app executing on the second display device 100-2 (S805).

When the second display device 100-2 is attached, the controller 170-1 of the first display device 100-1 may receive information on the app executing from the second display device 100-2 through the wireless communication interface 173-1. Information on the app may include one or more of identification information that identifies the app, the operating system of the app, the name of the app, and the version of the app.

The controller 170-1 of the first display device 100-1 may determine an app to be executed by the controller using information on the received app.

As an example, the controller 170-1 may execute the same app using the app identification information included in the received app information.

As another example, the controller 170-1 may determine one of the sub-apps of the app based on the received information on the app. For example, when the app executed by the second display device 100-2 is the execution screen of a menu app including a plurality of sub-apps, the first display device 100-1 may determine one of the plurality of sub-apps as the app to be executed. The determined app may be determined by user input or selection.

The controller 170-1 of the first display device 100-1 displays the execution screen of the determined app on the display 180-1 (S807).

Afterwards, the controller 170-1 of the first display device 100-1 determines whether the second display device 100-2 has been detached (S809).

When the second display device 100-2 is detached, the controller 170-1 of the first display device 100-1 returns to the previous screen (S811) and transmits a detachment notification to the second display device 100-2 (S813).

The second display device 100-2 returns to the previous screen upon receipt of the attachment/detachment notification (S815).

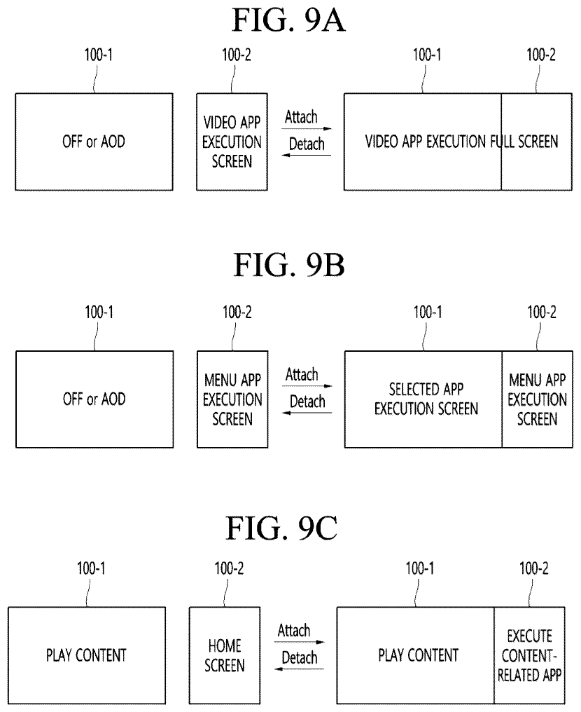

FIGS. 9a to 9c is a view illustrating a process in which an application to be executed on the first display device is determined according to an application running on the second display device when the second display device is attached to the first display device according to an embodiment of the present disclosure.

Referring to FIG. 9a, the first display device 100-1 is in a screen off state or AOD state. The second display device 100-2 displays an execution screen of a video app for video playback.

When the second display device 100-2 is attached, the first display device 100-1 may receive information on the video app from the second display device 100-2.

The first display device 100-1 determines whether the same app as the app executed by the second display device 100-2 is installed, and if the same app is installed, the first display device 100-1 may execute the video app.

The first display device 100-1 and the second display device 100-2 may play videos played only on the existing second display device 100-2 on an enlarged screen.

If the second display device 100-2 is detached from the first display device 100-1, each display device may return to the previous screen state thereof.

Next, FIG. 9b will be described.

Referring to FIG. 9b, the first display device 100-1 is in a screen off state or AOD state. The second display device 100-2 displays an execution screen of a menu app including a plurality of sub-apps.

When the second display device 100-2 is attached, the first display device 100-1 may receive information on the menu app from the second display device 100-2.

The first display device 100-1 may execute any one app among sub-apps that are sub-elements of the menu app.

In one embodiment, when the first display device 100-1 is attached and an app is selected among a plurality of sub-apps, the second display device 100-2 may determine the selected app as the app to be executed.

As shown in FIG. 9b, when attached to the second display device 100-2, the first display device 100-1 may display an execution screen of an app selected among sub-apps of a menu app.

If the second display device 100-2 is detached from the first display device 100-1, each display device may return to the previous screen state thereof.

Referring to FIG. 9c, the first display device 100-1 is playing content, and the second display device 100-2 is displaying a home screen.

When the second display device 100-2 is attached, the first display device 100-1 may transmit a command to the second display device to execute an app related to the content being played on the first display device 100-1 (100-2).

The second display device 100-2 may execute an app related to content according to a command received from the first display device 100-1 and display an execution screen of the app.

The app related to the content being played may be determined according to the genre or type of the content.

For example, if the genre of the content is a movie, the related app may be a content provider app that services movies.

As another example, when the type of content is a game video, the related app may be a game app corresponding to the game video.

If the second display device 100-2 is detached from the first display device 100-1, each display device may return to the previous screen state thereof.

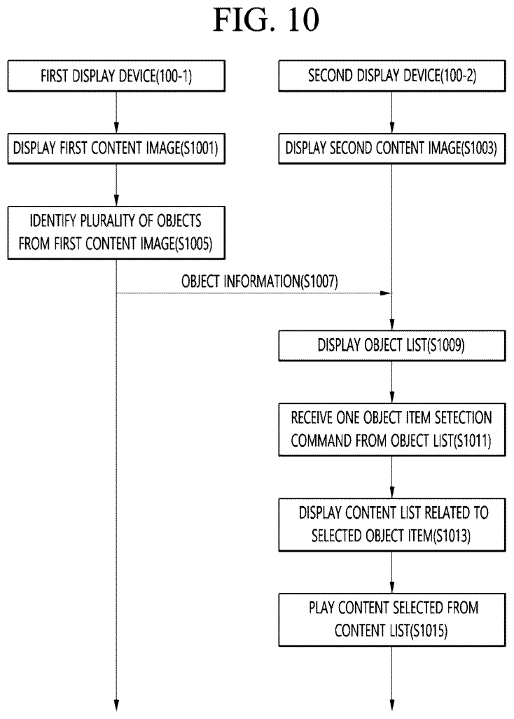

FIG. 10 is a ladder diagram for describing a method of operating a display system according to another embodiment of the present disclosure.

Hereinafter, it is assumed that FIG. 10 shows an embodiment in a state where the first display device 100-1 and the second display device 100-2 are attached.

In the embodiment of FIGS. 6 to 9c, the embodiment of FIG. 10 may be used after the first display device 100-1 and the second display device 100-2 are attached.

Referring to FIG. 10, the controller 170-1 of the first display device 100-1 displays the third content image on the display 180-1 (S1001).

In the embodiment of FIG. 6, the third content image may be a second content image displayed when attached to the second display device 100-2. The second display device 100-2 may be displaying the first content image of FIG. 6.

The controller 170-1 of the first display device 100-1 identifies a plurality of objects from the third content image (S1005).

The object may be either a person or an object. In particular, the object may be a person's face.

The controller 170-1 may identify a plurality of objects from the third content image using a known image recognition technology. The controller 170-1 may obtain identification information for each identified object. Identification information of an object may include the name of the object.

The controller 170-1 may identify a plurality of objects from the third content image according to a command received from the remote control device 200. The user may create a command by selecting a preset button provided on the remote control device 200 or an icon included in the third content image.

In one embodiment, the controller 170-1 may capture an image at the time a command for object extraction is received from the remote control device 200 and extract a plurality of objects from the captured image.

The controller 170-1 of the first display device 100-1 transmits object information including information on each of the identified plurality of objects to the second display device 100-2 through the wireless communication interface 173 (S1007).

The controller 170-2 of the second display device 100-2 displays an object list including a plurality of object items on the display 180-2 based on the received object information (S1009).

Each object item may be information that identifies the object, such as the name of the object.

The controller 170-2 of the second display device 100-2 receives a command to select an object item from the object list (S1011).

The controller 170-2 may receive a command to select an object item through the remote control device 200 or through a user's touch input.

The controller 170-2 of the second display device 100-2 displays a content list including a plurality of contents related to the selected object item (S1013).

When an object item is selected, the controller 170-2 may search a plurality of contents corresponding to the selected object item.

The controller 170-2 may search a plurality of contents using object items through a preset search engine. The controller 170-2 may display a content list including a plurality of searched contents on the display 180-2.

The controller 170-2 of the second display device 100-2 plays content selected from the content list (S1015).

The controller 170-2 may play the selected content according to a command for selecting one of a plurality of contents included in the content list.

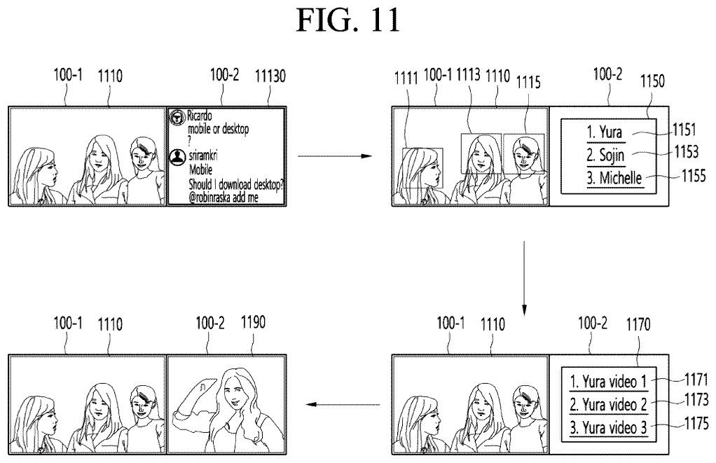

FIG. 11 is a view illustrating a usage scenario of the embodiment of FIG. 10.

Referring to FIG. 11, the first display device 100-1 and the second display device 100-2 are in an attached state. The first display device 100-1 displays the third content image 1110, and the second display device 100-2 displays the fourth content image 1130.

The first display device 100-1 may receive a command for extracting an object from the remote control device 200. The first display device 100-1 may extract a plurality of objects 1111, 1113, and 1115 from the third content image 1110 according to the received command. Here, the object may be a person.

Whether the object to be extracted is a person or an object may vary according to the type of command received from the remote control device 200.

The first display device 100-1 may transmit object information including identification information for each of the extracted plurality of objects 1111, 1113, and 1115 to the second display device 100-2.

The second display device 100-2 may display an object list 1150 including a plurality of object items 1151, 1153, and 1155 corresponding to each of the plurality of objects. At this time, the first display device 100-1 may be playing the third content image 1110.

Each object item may be the name of a person, but this is only an example.

When receiving a command to select the first object item 1151 among the plurality of object items 1151, 1153, and 1155, the second display device 100-2 may search the content related to the first object item 1151 and display content list 1170 according to the search result. At this time, the first display device 100-1 may be playing the third content image 1110.

The content list 1170 may include a plurality of content items 1171, 1173, and 1175 representing videos, movies, or the like, in which the person indicated by the first object item 1151 appears. Each content item may represent access information for an image or website.

The second display device 100-2 may play content 1190 corresponding to the first content item according to a command for selecting the first content item among the plurality of content items 1171, 1173, and 1175. At this time, the first display device 100-1 may be playing the third content image 1110.

As such, according to an embodiment of the present disclosure, while watching a content image through the main screen, a user can conveniently check information on an object identified from the content image through the main screen and the attached sub-screen.

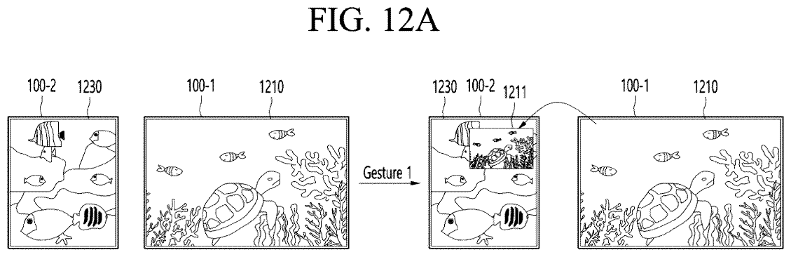

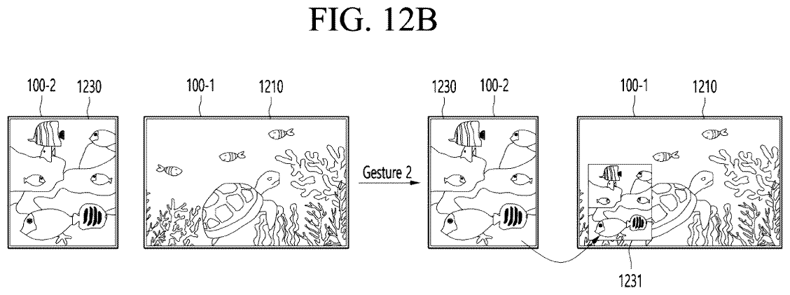

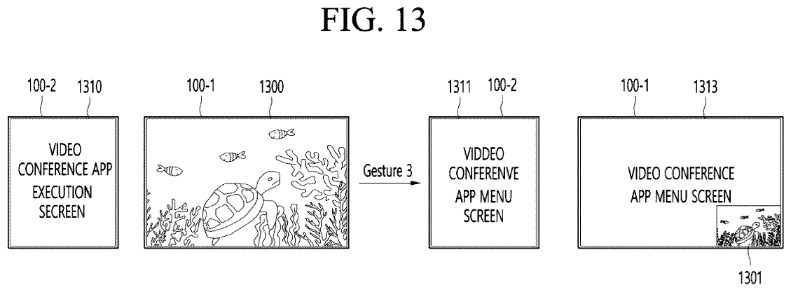

FIGS. 12a to 13 are views illustrating a process of switching the screen according to a gesture in a state where the first display device and the second display device are separated.

Hereinafter, it is assumed that the first display device 100-1 and the second display device 100-2 are physically separated and wirelessly connected to each other.

Additionally, the embodiments of FIGS. 12a to 13 may be combined with the embodiments of FIGS. 6 to 11 when the first display device 100-1 and the second display device 100-2 are separated.

Referring to FIG. 12a, the first display device 100-1 displays a first content image 1210, and the second display device 100-2 displays a second content image 1230.

When receiving the first gesture input, the first display device 100-1 may transmit a mirroring request for the first content image 1210 to the second display device 100-2. The second display device 100-2 may receive an image signal corresponding to the first content image 1210 according to the mirroring request and display the first mirroring image 1211 based on the received image signal.

The first mirroring image 1211 may be displayed on part or the entire screen of the second display device 100-2.

The first gesture input may be a swipe input that moves the touch input toward the second display device 100-2, but this is only an example.

Referring to FIG. 12b, the first display device 100-1 displays a first content image 1210, and the second display device 100-2 displays a second content image 1230.

When receiving the second gesture input, the first display device 100-1 may transmit a mirroring request for the second content image 1230 to the first display device 100-1. The first display device 100-1 may receive an image signal corresponding to the second content image 1230 according to the mirroring request and display a second mirroring image 1231 based on the received image signal.

The second mirroring image 1231 may be displayed on part or the entire screen of the first display device 100-1.

The second gesture input may be a swipe input that moves the touch input toward the first display device 100-2, but this is only an example.

Referring to FIG. 13, the first display device 100-1 displays a content image 1300, and the second display device 100-2 displays an execution screen 1310 of a video conference app that provides a video conference service.

The execution screen 1310 of the video conference app may include a main screen including a user image, an image of the other party, and a menu screen including menus for operating the video conference.

The second display device 100-2 may receive a third gesture input. The third gesture input may be a touch input of swiping in the direction where the first display device 100-1 is located.

The second display device 100-2 may display the menu screen 1311 of the video conference app according to the third gesture input. At the same time, the second display device 100-2 may transmit a request to display the main screen to the first display device 100-1, and the first display device 100-1 may display the main screen 1313.

The first display device 100-1 may receive an image signal corresponding to the main screen 1313. The first display device 100-1 may display a reduced image 1301 of the previously displayed content image 1300 overlapping the main screen 1313.

As such, according to the embodiment of the present disclosure, the user may easily control the dual screen with only simple gestures.

According to an embodiment of the present disclosure, the above-described method may be implemented as processor-readable code on a program-recorded medium. Examples of media that the processor can read include ROM, RAM, CD-ROM, magnetic tape, floppy disk, and optical data storage devices.

The display device described above is not limited to the configuration and method of the above-described embodiments, and the embodiments may be configured by selectively combining all or part of each embodiment so that various modifications may be made.

1. A display system including a first display device and a second display device,
wherein the first display device determines whether the second display device is attached, and based on a determination that the second display device is attached, the second display device displays a second content image related to a first content image based on the first content image being displayed by the second display device.

2. The display system of claim 1,
wherein a screen of the first display device is larger than a screen of the second display device, and
wherein the second content image is an enlarged image of the first content image.

3. The display system of claim 1,
wherein the second content image is a partial image of the first content image.

4. The display system of claim 1,
wherein the first display device determines whether the second display device is attached by detecting magnetic force between a magnet provided on one surface of the first display device and a magnet provided on one surface of the second display device.

5. The display system of claim 4,
wherein the first display device is wirelessly connected to the second display device through a wireless communication interface as the first display device is attached to the second display device.

6. The display system of claim 1,
wherein when the second display device is detached from the first display device, the second display device displays the second content image.

7. The display system of claim 1,
wherein the first display device identifies a plurality of objects from the second content image and transmits object information including information for each identified object to the second display device, and
wherein the second display device displays an object list based on the received object information.

8. The display system of claim 7,
wherein the second display device receives a command to select an object item from the object list, and displays a content list related to the selected object item according to the received command.

9. The display system of claim 8,
wherein the content list includes a plurality of contents representing a search result for the object item.

10. The display system of claim 9,
wherein the second display device plays the selected content upon receiving a command to select one of a plurality of contents.

11. The display system of claim 7,
wherein each object is either a person or an object.

12. The display system of claim 7,
wherein the first display device receives a command for object extraction from a remote control device, captures an image at a time of receiving the command, and identifies the plurality of objects from the captured image.

13. The display system of claim 8,
wherein the second display device searches for a plurality of contents related to the object according to the selection of the object item.
